(19) United States
(12) Patent Application Publication
(10) Pub. No.: US 2016/0238087 A1
(43) Pub. Date: Aug. 18, 2016

(54) Electromagnetic Clutch

(71) Applicant: SANDEN HOLDINGS CORPORATION, Isesaki-shi, Gunma (JP)

(72) Inventors: Akihiro MIKI, Isesaki-shi, Gunma (JP); Tomonori MATSUMURA, Isesaki-shi, Gunma (JP)

(21) Appl. No.: 15/027,647

(22) PCT Filed: Oct. 8, 2013
(86) PCT No.: PCT/JP2013/077386

§ 371 Date: Apr. 6, 2016

(51) Int. Cl. F16D 27/14; F16D 27/06

(52) U.S. Cl. CPC F16D 27/14; F16D 27/06

(57) ABSTRACT

Electromagnetic clutch having an electromagnetic coil 42 that causes magnetic attraction between a rotor and an armature is wound around bobbin 41. The bobbin includes: an inner wall 41d and an outer wall 41d, which extend opposite toward a bimetal; and an inner abutment portion 41g and an outer abutment portion 41f, which extend from each extension end of the inner wall 41d and the outer wall 41e toward inner and outer opening edges of a ring case 43 for accommodating the bobbin 41. The inner abutment portion 41f and the outer abutment portion 41g abut the inner and outer opening edges of the ring case 43, by which the bobbin 41 is positioned and accommodated in the ring case 43. In addition, a bridge wire 52 is stretched at the same height on the inner wall 41d and the outer wall 41e.

### TECHNICAL FIELD

The present invention relates to an electromagnetic clutch and more particularly to an electromagnetic clutch suitable for intermittently transmitting power of an engine or motor of a vehicle to an in-vehicle driven device (for example, a compressor in an air conditioner for use in a vehicle).

### BACKGROUND ART

As this type of electromagnetic clutches, for example, an electromagnetic clutch disclosed in Patent Document 1 has been known. The electromagnetic clutch disclosed in Patent Document 1 has an energization interrupting device configured to cut a cutting wire that forms a part of an electromagnetic coil to thereby forcibly interrupt electric power supply to the electromagnetic coil if a rotor temperature exceeds a predetermined temperature due to relative sliding between friction surfaces of a rotor and an armature. In this energization interrupting device, a thermally-actuated device is provided in the rotor and the cutting wire is provided in the electromagnetic coil unit. When the rotor temperature increases beyond the predetermined temperature, the thermally-actuated element is displaced by a predetermined distance toward the electromagnetic coil unit and then engaged with the cutting wire to cut the cutting wire.

### REFERENCE DOCUMENT LIST

### Patent Document

Patent Document 1: JP H01-210626 A

### SUMMARY OF THE INVENTION

### Problems to be Solved by the Invention

Note that in the energization interrupting device provided with the thermally-actuated element and the cutting wire, the thermally-actuated element and the cutting wire should be positioned opposite to each other in a narrow space between the rotor and the electromagnetic coil unit. Thus, if it fails to precisely control a relative distance between the thermally-actuated element and the cutting wire in the axial direction of the electromagnetic clutch, or the direction in which the thermally-actuated element is displaced, the following problem occurs. That is, the energization interrupting device causes an operation error to unintentionally cut the cutting wire or fail to cut the wire. Since the thermally-actuated element is fixed to the rotor, its position in the axial direction of the electromagnetic clutch is defined at the design state according to the sizes of the rotor and bearing and the size of a housing of a driven device where the rotor is positioned and fixed. In addition, the displacement amount of the thermally-actuated element is determined in consideration of design factors such as materials and sizes. Regarding the position of the cutting wire in the axial direction of the electromagnetic clutch, the positional accuracy thereof varies depending on how the cutting wire is mounted to an end surface of the electromagnetic coil unit on the rotor side. If the cutting wire is not appropriately mounted, the position of the cutting wire varies largely in the axial direction of the electromagnetic clutch. As a result, the above operation error occurs and the reliability of the energization interrupting device lowers.

Regarding the energization interrupting device of the electromagnetic clutch disclosed in Patent Document 1, the document only remarks that winding end of an electromagnetic coil is engaged with a hook of a bobbin and used as a cutting wire. There is no description about the way to control the position of the cutting wire in the axial direction of the electromagnetic clutch.

The present invention has been made in view of the above problems and an object of the present invention is to provide an electromagnetic clutch that facilitates positional control of the cutting wire and enhances reliability of the energization interrupting device.

### Means for Solving the Problems

In order to achieve the above object, the present invention provides an electromagnetic clutch, including: a rotor unit provided with a rotor that is rotated with power of a driving source, and rotatably supported to a boss formed on an end surface of a housing of a driven device; an armature unit provided with an armature that is magnetically attracted to the rotor when the rotor is excited, and fixed to a rotation shaft of the driven device, which passes through the boss; an electromagnetic coil unit including: a bobbin having first and second flanges on both sides of a cylindrical portion with an electromagnetic coil wound around an outer circumference of the cylindrical portion positioned between the flanges, the coil serving to excite the rotor in response to electric power supply; and a ring case provided with a circular bobbin container and accommodated in a circular recess formed in the rotor, the ring case being fixed to the end surface of the housing of the driven device with an opening edge of the bobbin container facing toward the rotor; and a thermally-actuated element attached to the rotor unit, and displaced toward the electromagnetic coil unit at over a predetermined temperature, the thermally-actuated element serving to cut a cutting wire portion that forms a part of the electromagnetic coil to forcibly interrupt electric power supply to the electromagnetic coil, with the wire being placed toward the electromagnetic coil unit across a movement area of the thermally-actuated element. In the clutch, the bobbin includes: first and second wall portions extending opposite to each other from the first flange formed on the opening edge in the bobbin container toward a bottom wall in the circular recess of the rotor where the thermally-actuated element is mounted; an inner abutment portion extending from an extension end of the first wall portion toward an inner opening edge of the bobbin container; and an outer abutment portion extending from an extension end of the second wall portion toward an outer opening edge of the bobbin container. The bobbin is accommodated into the bobbin container such that the inner abutment portion and the outer abutment portion abut inner and outer opening edges of the bobbin, respectively. The cutting wire portion is stretched between both of the wall portions at a predetermined distance from an end surface of each of the first and second wall portions.

### Effects of the Invention

According to the electromagnetic clutch of the present invention, while the inner and outer abutment portions of the bobbin are engaged with an opening edge of the bobbin container of the ring case, the bobbin having the electromagnetic coil wound thereon is positioned and accommodated into the bobbin container. Thus, it is possible to define the position of the bobbin in the bobbin container in the axial direction of the electromagnetic clutch, and also to precisely position the cutting wire portion stretched between the first wall portion and the second wall portion, in the axial direction of the electromagnetic clutch. The reliability of the energization interrupting device can be enhanced as well.

### BRIEF DESCRIPTION OF THE DRAWINGS

FIG. 1 is a sectional view of an electromagnetic clutch according to an embodiment of the present invention.

FIG. 2 is a front view of a rotor unit.

FIG. 3 is a sectional view taken along the line A-O-A of FIG. 2.

FIG. 4 is a sectional view of an armature unit.

FIG. 5 is a sectional view of an electromagnetic coil unit.

FIG. 6 is a sectional view of a bobbin in the electromagnetic coil unit.

FIG. 7 is an enlarged view of a bridge wire viewed from the arrow A of FIG. 5.

FIG. 8 is a view of the bridge wire viewed from the arrow B of FIG. 7.

FIG. 9 is a view of the bridge wire viewed from the arrow C of FIG. 7.

FIG. 10 is an enlarged sectional view of the bridge wire taken along the line D-D of FIG. 7.

FIG. 11 is an explanatory operational view of an energization interrupting device under the condition that bimetal is not displaced.

FIG. 12 is a sectional view of the bimetal of FIG. 11.

FIG. 13 is an explanatory operational view of the energization interrupting device under the condition that the bimetal is displaced beyond a predetermined distance.

FIG. 14 is a sectional view of the bimetal of FIG. 13.

### MODES FOR CARRYING OUT THE INVENTION

An embodiment of the present invention will be described hereinafter with reference to the accompanying drawings.

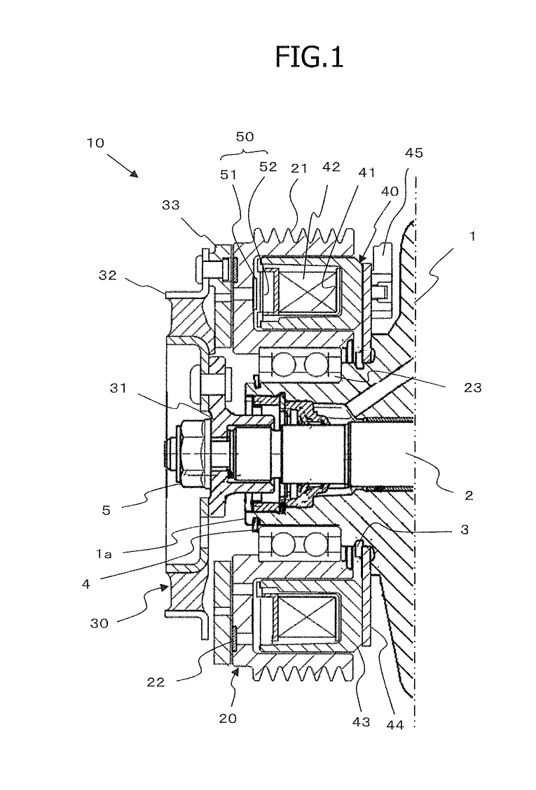

FIG. 1 shows the structure of an electromagnetic clutch according to the embodiment of the present invention. An electromagnetic clutch 10 of this embodiment is incorporated, for example, in a compressor for an in-vehicle air conditioner and configured to intermittently transmit power from a vehicle engine or motor as a driving power source to the compressor as a driven device. In other words, the electromagnetic clutch 10 switchingly transmits/interrupts power from the engine or the motor to the compressor. The compressor is operated when power is transmitted from the engine or motor, and stops operation when power transmission is interrupted. The compressor of the present invention could be, for example, a swashplate type variable-displacement compressor. Here, it is possible to employ variable-displacement compressors of other types or fixed-displacement compressors of scroll type, vane type, etc.

In FIG. 1, the electromagnetic clutch 10 includes a rotor unit 20, an armature unit 30, and an electromagnetic coil unit 40 and in addition, an energization interrupting device 50.

The rotor unit 20 is rotated with power of an engine or motor, and provided with a rotor 21, a friction member 22, and a bearing 23.

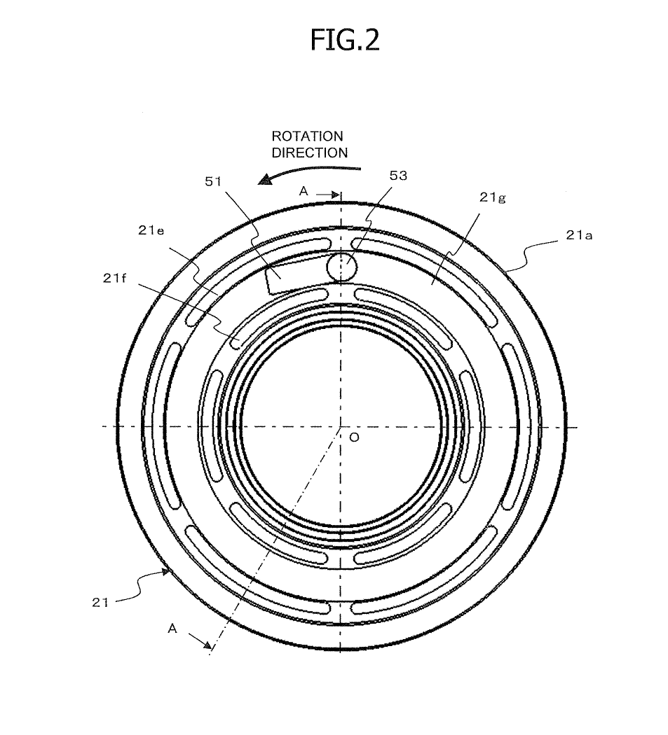

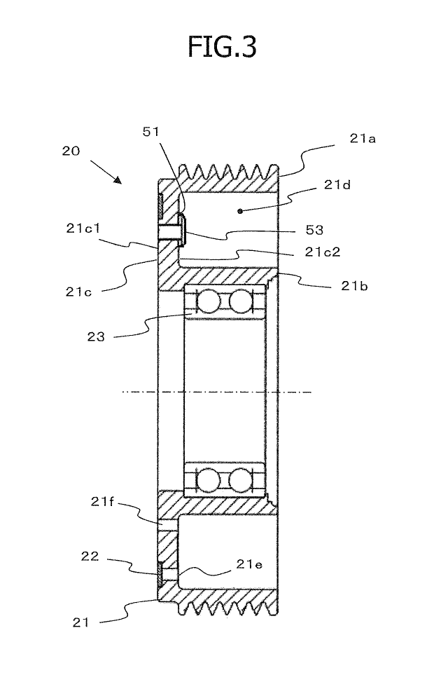

The rotor 21 has a circular shape. The inner circumference thereof is rotatably supported to the outer circumference of a boss 1a as an end surface of a front housing 1 of the compressor by means of the bearing 23. On the outer circumference of the rotor 21, formed are grooves to which a belt for transmitting a rotational force from the engine or motor is hooked. More specifically, as shown in FIGS. 2 and 3, the rotor 21 is integrally constituted of an outer cylindrical portion 21a having the outer circumference with the belt grooves formed therein, an inner cylindrical portion 21b having the inner circumference, and an end surface portion 21c connecting the outer cylindrical portion 21a and the inner cylindrical portion 21b. The outer cylindrical portion 21a, the inner cylindrical portion 21b, and the end surface portion 21c are formed of a ferromagnetic material (specific example: iron material). These members form a circular recess 21d that accommodates an electromagnetic coil 42 in the electromagnetic coil unit 40 as described below. Arc-shaped slits 21e and 21f are formed in the end surface portion 21c and used to divert magnetic flux generated in the electromagnetic coil 42. In addition, between the arc-shafted slits 21e and 21f on a bottom end surface portion 21c2 of the end surface portion 21c in the circular recess 21d, formed is a circular groove 21g (see FIGS. 2, 11, and 12) where a bimetal 51 of the energization interrupting device 50 as described below is attached. A friction surface 21c1 is an end surface of the end surface portion 21c opposite to the bottom end surface portion 21c2 of the circular recess 21d. The friction member 22 is made of a circular nonmagnetic material to increase friction coefficient and attached to the friction surface 21c1. Discussing the structure of the bearing 23, as shown in FIG. 1, the inner ring side thereof is positioned to the outer circumference of the boss 1a of the front housing 1 and fixed thereto with a snap ring 4. The bearing rotatably supports the rotor 21 onto the outer circumference of the boss 1a as a part of the end surface of the front housing 1.

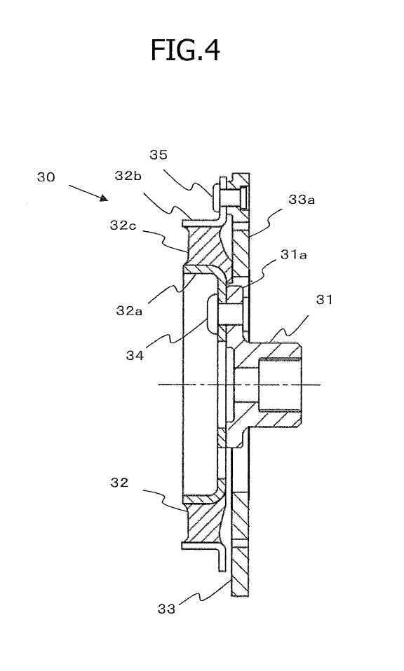

The armature unit 30 transmits a power from an engine or motor to a compressor when an armature 33 is magnetically attracted to the rotor 21 in response to electric power supply to the electromagnetic coil 42. As shown in FIG. 4, the unit includes a hub 31, a rubber unit 32, and the armature 33.

The hub 31 is provided with a flange portion 31a and fixed to the tip end of a rotation shaft 2 of the compressor by means of a nut 5 (see FIG. 1). The rubber unit 32 includes an inner ring 32a, an outer ring 32b, and a circular rubber 32c interposed by cure adhesion between the inner ring 32a and the outer ring 32b. The inner ring 32a is fixed to the flange portion 31a of the hub 31 with a rivet 34. The armature 33 is a circular plate member with one end surface that serves as a friction surface 33a facing the friction surface 21c1 of the rotor 21 at a predetermined interval. The armature is fixed to the outer ring 32b of the rubber unit 32 with a rivet 35 and elastically supported by the circular rubber 32c. The armature 33 is formed of a ferromagnetic material (specific example: iron material). The armature constitutes a magnetic circuit together with the rotor 21. In response to electric power supply to the electromagnetic coil 42, the armature is magnetically attracted to the rotor 21. Meanwhile, when magnetic attraction power is extinguished due to interruption of electric power supply, the armature moves away from the rotor 21.

The electromagnetic coil unit 40 generates a magnetic attraction power by magnetizing the rotor 21. The unit includes a bobbin 41, the electromagnetic coil 42 wound around the bobbin, a ring case 43 having a circular recess that serves as a bobbin container for accommodating the bobbin 41, an annular disc-like fixing member 44 fixed to the ring case 43 and configured to form the other end surface of the electromagnetic coil unit 40, and a connecting portion 45 for connecting an external power supply in the vehicle and the electromagnetic coil 42.

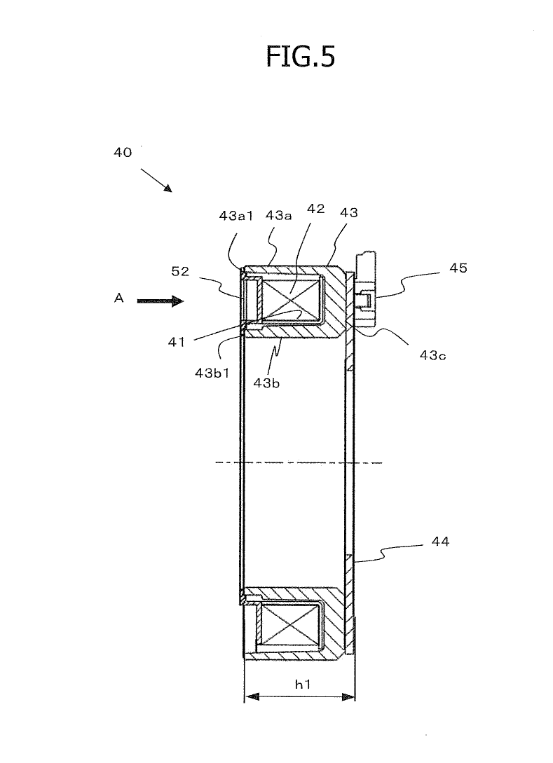

As shown in FIG. 5, the ring case 43 has a circular recess integrally formed by an outer cylindrical portion 43a, an inner cylindrical portion 43b, and an end surface portion 43c that connects the outer cylindrical portion 43a and the inner cylindrical portion 43b. The recess accommodates the bobbin 41 having the electromagnetic coil 42 wound therearound. The recess is inserted into a circular recess 21d of the rotor 21 in a relatively rotatable manner with its opening facing toward the rotor 21. The outer cylindrical portion 43a and an inner cylindrical portion 43b are coaxial with the axial line of the rotation shaft 2 of the compressor. The end surface portion 43c is orthogonal to the axial line of the rotation shaft 2. An end surface 43a1 of the outer cylindrical portion 43a (outer circumference side opening edge) and an end surface 43b1 of the inner cylindrical portion 43b (inner circumference side opening edge) extend flush with each other and orthogonally to the axial line of the rotation shaft 2. The outer cylindrical portion 43a, the inner cylindrical portion 43b, and the end surface portion 43c are formed of a ferromagnetic material (for example, iron material) to constitute a magnetic circuit.

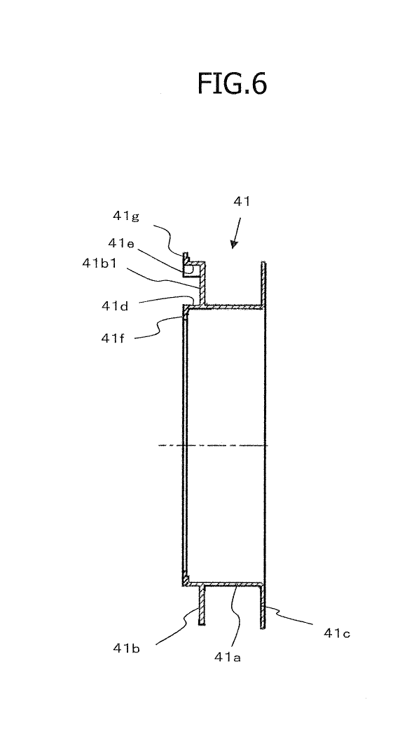

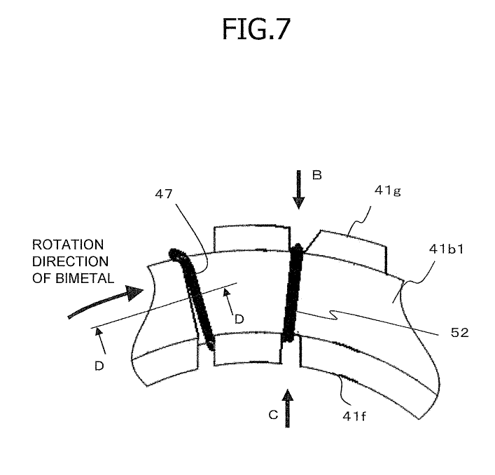

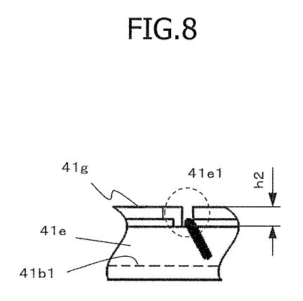

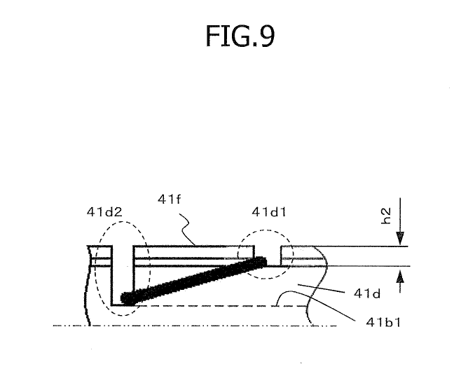

As shown in FIG. 6, the bobbin 41 includes the cylindrical portion 41a, and a first flange 41b and a second flange 41c, which extend radially outwardly from each end of the cylindrical portion 41a opposite to each other. The electromagnetic coil 42 is wound around the outer circumference of the cylindrical portion 41a formed between the flanges 41b and 41c. The bobbin 41 also has an inner wall 41d as a first wall portion and an outer wall 41e as a second wall portion, which face each other and extend from a proximal end and a tip end of the first flange 41b respectively toward a bottom wall 21c2 of the circular recess 21d of the rotor 21. The inner wall 41d is formed at substantially the entire circumference of the proximal end of the first flange 41b. Similarly formed at substantially the entire circumference thereof is an inner abutment portion 41f that extends radially inwardly from the tip end thereof (end of the extension) such that the portion can abut an inner opening edge of the circular recess as the bobbin container. Further, as shown in FIG. 7, the outer wall 41e is formed only in the vicinity of a predetermined portion of the tip end of the first flange 41b (the winding end of the electromagnetic coil 42). An outer abutment portion 41g extends radially outwardly from the tip end (end of the extension) such that the portion can abut the outer opening edge of the circular recess as the bobbin container. In addition, as indicated by the dashed circle in FIG. 8, the outer wall 41e of the bobbin 41 has a first slit 41e1 with a predetermined distance from the tip end (upper surface of the outer abutment portion 41g), in other words, a predetermined depth h2 (corresponding to the thickness of the outer abutment portion 41g). Moreover, as indicated by the dashed circle in FIG. 9, the inner wall 41d of the bobbin 41 has a second slit 41d1 with a predetermined distance from the tip end (upper surface of the inner abutment portion 41f), in other words, the same depth h2 as the first slit 41e1 (corresponding to the thickness of the inner abutment portion 41f), and a third slit 41d2 extending from the tip end (upper surface of the inner abutment portion 41f) down to a first flange surface 41b1. The bobbin 41 includes the cylindrical portion 41a, the first flange 41b, the second flange 41c, the inner wall 41d, the outer wall 41e, the inner abutment portion 41f, and the outer abutment portion 41g, which are integrally formed of a plastic material, for example, a polyamide resin.

The electromagnetic coil unit 40 is securely insulated by pouring a resin through the space between the ring case 43 and the bobbin 41 accommodated into the circular recess of the ring case 43. As shown in FIG. 5, the bobbin 41 is accommodated in the ring case 43 in such a way that the outer abutment portion 41g of the bobbin 41 abuts against the end surface 43a1 of the outer cylindrical portion 43a of the ring case 43, and the inner abutment portion 41f abuts the end surface 43b1 of the inner cylindrical portion 43b of the ring case 43. In this way, the bobbin 41 is positioned to the circular recess of the ring case 43 and thus accommodated and fixed thereto. The fixing member 44 fixed to the end surface of the end surface portion 43c opposite to the bottom wall of the circular recess is positioned to the end surface of the front housing 1 and fixed thereto with the snap ring 3 as shown in FIG. 1 and hence, the electromagnetic coil unit 40 is fixed to the end surface of the front housing 1.

When heat is generated due to relative sliding between the rotor 21 and the armature 31, the energization interrupting device 50 forcibly interrupts electric power supply to the electromagnetic coil 42. The energization interrupting device 50 is provided with thermally-actuated elements, for example, the bimetal 51 and the bridge wire 52 serving as a cutting wire portion that forms a part of the electromagnetic coil 42.

The bimetal 51 is formed in a substantially rectangular shape and accommodated in the circular groove 21g formed in the bottom wall 21c2 of the circular recess 21d in the rotor 21. One end thereof is fixed with a rivet 53, and the other end faces toward the rotation direction of the rotor 21. Note that the bimetal 51 could be fixed by any other fixing member such as a bolt. Since the bimetal 51 is accommodated and positioned in the circular groove 21g, when engaged with the bridge wire 52, the bimetal 51 can be prevented from tilting to the left or right relative to the rotation direction of the rotor 21 in response to the reaction force of the bridge wire 52. If sensing the temperature higher than a predetermined level, the bimetal 51 is displaced beyond a predetermined distance toward the electromagnetic coil unit 40. The bimetal 51 is preferably a snap action type that starts inverted motion at a predetermined temperature. The snap action type bimetal is hardly displaced at a temperature lower than an inverted motion temperature (temperature causing inverted motion) but is largely displaced at over the inverted motion temperature. By utilizing the inverted motion, the bridge wire 52 is cut. In general, in a compressor for an in-vehicle air conditioner, the electromagnetic clutch 10 could increase the temperature up to 150° C. Taking this temperature into account to set the inverted motion temperature for interrupting electric power supply to the electromagnetic coil 42, the temperature is appropriately set to 180° C. to 190° C.

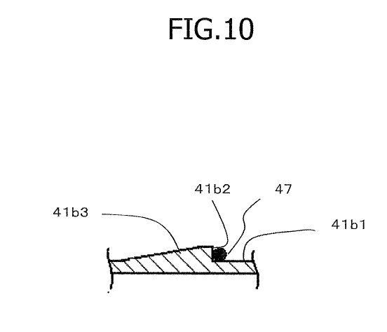

The bridge wire 52 is obtained from the winding end (the ground side of the electromagnetic coil 42) of the electromagnetic coil 42 wound around the bobbin 41. The wire is stretched on one end surface of the electromagnetic coil unit 40 opposite to the bottom wall 21c2 in the circular recess 21d of the rotor 21 such that the wire crosses an area where the bimetal 51 moves along with the rotation of the rotor 21 (movement area of the bimetal 51) and also is engaged with the bimetal 51 displaced beyond a predetermined distance. More specifically, as shown in FIGS. 7 to 10, the winding end of the electromagnetic coil 42 wound around the bobbin 41 is inserted into the first slit 41e1 from one side (radially outer portion of the bobbin 41) of the outer wall 41e, the other side of which faces the inner wall 41d. The inserted wire crosses a space surrounded by the outer wall 41e, the inner wall 41d, and the first flange 41b. Then, the wire is inserted into the second slit 41d1 so as to stretch between the slits. The wire is thus positioned and supported to the end surfaces of both the slits 41e1 and 41d1. The stretched wire serves as the bridge wire 52. Subsequently, the wire is inserted into the third slit 41d2 of the inner wall 21d from one side (radially inner portion of the bobbin 41) of the inner wall 21d, the other side of which faces the outer wall 41e. The inserted wire is guided along a guide wall 41b2 (see FIG. 10) formed on the first flange surface 41b1 of the first flange 41b toward the outer wall 41e across the first flange surface 41b1 of the first flange 41b. The wire is routed outwardly in the radial direction of the bobbin 41. Thus, the wire is stretched between the outer wall 41e and the inner wall 41d over the first flange 41b. The thus-formed wire serves as the bridge wire 52. The inner abutment portion 41f and the outer abutment portion 41g are formed at the same height from the first flange surface 41b1 of the first flange 41b. The first slit 41e1 and the second slit 41d1 are formed at the same depth h2. Thus, the bridge wire 52 is stretched in parallel to the first flange surface 41b1 of the first flange 41b at a predetermined height.

As shown in FIG. 10, an inclined surface 41b3 is formed above the first flange surface 41b1 of the first flange 41b of the bobbin 41 such that the inclined surface slopes up toward the rotation direction of the bimetal 51. The terminal end of the inclined surface 41b3 and the first flange surface 41b1 of the first flange 41b form a step serving as the guide wall 41b2. An electromagnetic coil portion 47 is guided along the step to cross above the first flange surface 41b1 of the first flange 41b from the radially inner portion to the radially outer portion of the bobbin 41. The step height, i.e., the height of the inner wall 41b2 from the first flange surface 41b1 is set equal to or slightly larger than the outer diameter of the electromagnetic coil portion 47.

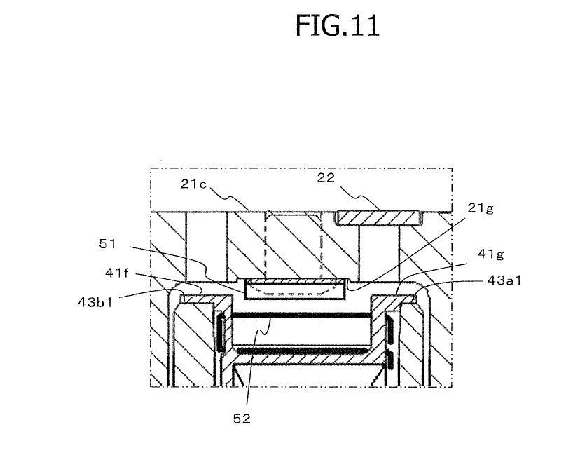

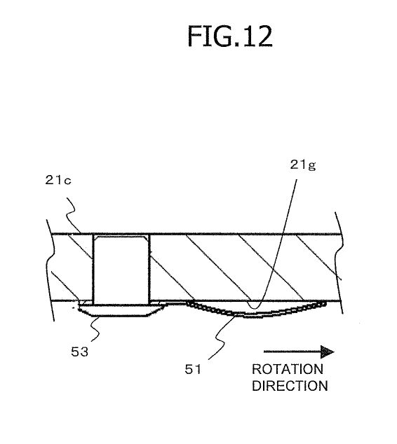

Here, a brief description is given of the general operation of intermittently transmitting power to the compressor by means of the electromagnetic clutch 10 and the operation of the energization interrupting device 50. If electric power is supplied to the electromagnetic coil 42 of the electromagnetic coil unit 40 under the condition that the rotor 21 is rotated with a rotational force from the engine, the rotor 21 is excited, and the generated electromagnetic force makes the armature 33 magnetically attracted to the rotor 21. Then, the armature 33 is rotated in sync with the rotor 21. The rotational force of the armature 22 is transmitted to the rotation shaft 2 of the compressor by way of the rubber unit 32 and the hub 31 to thereby operate the compressor. If the electric power supply to the electromagnetic coil 42 of the electromagnetic coil unit 40 is interrupted in this state, the rotor 21 is demagnetized, and the armature 33 is retracted from the rotor 21 due to a restoring force of the rubber 32c. No rotational force of the rotor 21 is transmitted to the armature 33. As a result, the rotation shaft 2 stops rotating and the compressor stops the operation. In the normal state, the temperature of the end surface portion 21c of the rotor 21 does not reach the predetermined temperature at which the bimetal 51 is displaced over the predetermined distance. As shown in FIGS. 11 and 12, the bimetal 51 is rotated integrally with the rotor 21 without contacting the bridge wire 52.

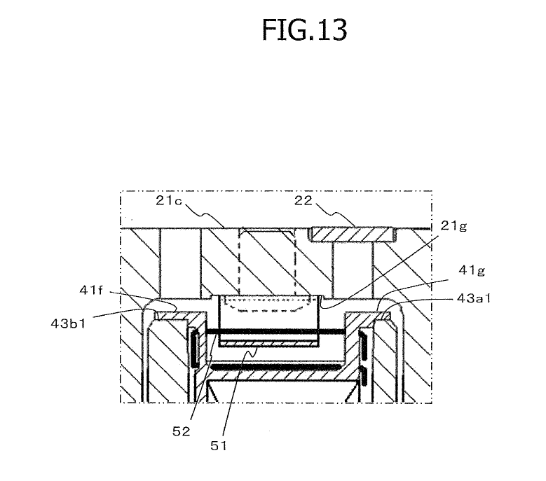

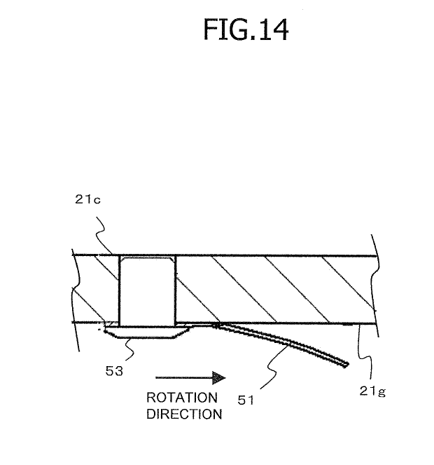

On the other hand, if an excessively larger torque than usual acts on the rotation shaft 2 due to, for example, damaged inner parts of the compressor, the contact surfaces of the rotor 21 and the armature 33 slide on each other to generate the friction heat, resulting in rapid temperature rise at the end surface portion 21c of the rotor 21. When the temperature of the end surface portion 21c increases rapidly, as shown in FIGS. 13 and 14, the free end of the bimetal 51 is displaced toward the electromagnetic coil unit 40. If the temperature exceeds the predetermined temperature, the free end of the bimetal 51 is displaced beyond the predetermined distance and engaged with the bridge wire 52 to cut the bridge wire 52. As a result, electric power supply to the electromagnetic coil 42 is forcibly interrupted and the armature 33 is retracted from the rotor 31. This makes it possible to prevent the engine from an excessive load, protect the belt against any damage, and ensure driving safety of the vehicle.

According to the electromagnetic clutch 1 of this embodiment, the outer abutment portion 41g and the inner abutment portion 41f of the bobbin 41 abut against the end surface 43a1 of the outer cylindrical portion 43a of the ring case 43 and the end surface 43b1 of the inner cylindrical portion 43b, by which the bobbin 41 is positioned and accommodated in the circular recess of the ring case 43. The inner abutment portion 41f and the outer abutment portion 41g have the same height from the first flange surface 41b1 of the first flange 41b and also, the depth from the end surface of the outer wall 41e to the bottom of the first slit 41e1 is the same (depth h2) as that from the end surface of the inner wall 41d to the bottom of the second slit 41d1. Thus, the bridge wire 52 is stretched in parallel to the first flange surface 41b1 at a predetermined height from the first flange surface 41b1 of the first flange 41b. By precisely controlling the height h1 (see FIG. 5) from the end surface (reference surface) where the fixing member 44 is attached on the front housing 1 side, up to the end surfaces 43a1 and 43b1 of the outer cylindrical portion 43a and the inner cylindrical portion 43b, respectively, of the ring case 43, it is possible to precisely position the bridge wire 52 in the axial direction of the electromagnetic clutch. Similarly, the first flange surface 41b1 of the first flange 41b of the bobbin 41 can be precisely positioned in the circular recess of the ring case 43 as the bobbin container. The above structure enables precise control on a relative distance between the bimetal 51 and the bridge wire 52 whose positions in the axial direction of the electromagnetic clutch can be determined at the design stage.

Consider the possibility that, if the bimetal 51 is largely displaced, the displaced end portion of the bimetal 51 abuts the electromagnetic coil portion 47 that crosses over the first flange surface 41b1 of the first flange 41b of the bobbin 41 and the bimetal 51 is damaged thereby. In this embodiment, since the first flange surface 41b1 of the first flange 41b has the inclined surface 41b3, the displaced end portion is guided along the inclined surface 41b3 and thus goes over the electromagnetic coil portion 47. Therefore, the displaced end portion of the bimetal 51 is never engaged with the electromagnetic coil portion 47 and the bimetal can be protected. This realizes precise control on a relative distance between the bimetal 51 and the bridge wire 52 in the axial direction of the electromagnetic clutch, making it possible to protect the bimetal 51 even when the bimetal 51 is largely displaced and also to considerably improve the reliability of the energization interrupting device.

The inner wall 41d, the outer wall 41e, the inner abutment portion 41f, and the outer abutment portion 41g integrally form the bobbin 41. Thus, the bridge wire 52 can be easily obtained in the process for winding the electromagnetic coil 42 around the bobbin 41. This realizes cost reduction of the electromagnetic clutch 1 even though the energization interrupting device is provided.

While the above embodiment shows an example where the bimetal is used as a thermally-actuated element, other thermally-actuated elements such as shape memory alloy are applicable. Further, although the above embodiment shows an example where the electromagnetic clutch is attached to the compressor used for the in-vehicle air conditioner, the electromagnetic clutch can be used for the other purposes without any limitation.

### REFERENCE SYMBOL LIST

1 . . . Housing
2 . . . Rotation shaft
10 . . . Electromagnetic clutch
20 . . . Rotor unit
21 . . . Rotor
21d . . . Circular recess
30 . . . Armature unit
33 . . . Armature
40 . . . Electromagnetic coil unit
41 . . . Bobbin
42 . . . Electromagnetic coil
41a . . . Cylindrical portion
41b . . . First flange
41c . . . Second flange
41d . . . Inner wall
41e . . . Outer wall
41f . . . Inner abutment portion
41g . . . Outer abutment portion
41b2 . . . Guide wall
41b3 . . . Inclined surface
41d1 . . . Second slit
41e1 . . . First slit
50 . . . Energization interrupting device
51 . . . Bimetal
52 . . . Bridge wire (cutting wire portion)

1. An electromagnetic clutch, comprising:
a rotor unit provided with a rotor that is rotated with power of a driving source, and rotatably supported to a boss formed on an end surface of a housing of a driven device;
an armature unit provided with an armature that is magnetically attracted to the rotor when the rotor is excited, and fixed to a rotation shaft of the driven device, which passes through the boss;
an electromagnetic coil unit including:
a bobbin having first and second flanges on both sides of a cylindrical portion with an electromagnetic coil wound around an outer circumference of the cylindrical portion positioned between the flanges, the coil serving to excite the rotor in response to electric power supply; and
a ring case provided with a circular bobbin container and accommodated in a circular recess formed in the rotor, the ring case being fixed to the end surface of the housing of the driven device with an opening edge of the bobbin container facing toward the rotor; and
a thermally-actuated element attached to the rotor unit, and displaced toward the electromagnetic coil unit at over a predetermined temperature, the thermally-actuated element serving to cut a cutting wire portion that forms a part of the electromagnetic coil to forcibly interrupt electric power supply to the electromagnetic coil, with the wire being placed toward the electromagnetic coil unit across a movement area of the thermally-actuated element,
wherein the bobbin includes:
first and second wall portions extending opposite to each other from the first flange formed on the opening edge in the bobbin container toward a bottom wall in the circular recess of the rotor where the thermally-actuated element is mounted;
an inner abutment portion extending from an extension end of the first wall portion toward an inner opening edge of the bobbin container; and
an outer abutment portion extending from an extension end of the second wall portion toward an outer opening edge of the bobbin container,
wherein the bobbin is accommodated into the bobbin container such that the inner abutment portion and the outer abutment portion abut inner and outer opening edges of the bobbin, respectively, and
wherein the cutting wire portion is stretched between both of the wall portions at a predetermined distance from an end surface of each of the first and second wall portions.

2. The electromagnetic clutch according to claim 1, wherein the first wall portion, the second wall portion, the inner abutment portion, and the outer abutment portion are formed of a plastic material integrally with the bobbin.

3. The electromagnetic clutch according to claim 1, wherein the cutting wire portion is stretched between the first wall portion and the second wall portion such that a winding end of the electromagnetic coil wound around the bobbin is stretched from a radially outer portion of the bobbin between the first wall portion and the second wall portion, and then routed from a radially inner portion of the bobbin to the radially outer portion thereof so as to cross over a surface of the first flange.

4. The electromagnetic clutch according to claim 3, wherein an inclined surface is formed on the surface of the first flange, the inclined surface sloping up toward a rotation direction of the thermally-actuated element,
a step portion formed by a terminal end of the inclined surface and the surface of the first flange is used as a guide wall, and
the cutting wire portion forming a part of the electromagnetic coil crosses along the guide wall over the surface of the first flange from the radially inner portion of the bobbin toward the radially outer portion of the bobbin.
